(19) United States
(12) Patent Application Publication
(10) Pub. No.: US 2014/0191572 A1
(43) Pub. Date: Jul. 10, 2014

(54) COMBINATORIAL POWER DISTRIBUTION SYSTEMS AND METHODS FOR CONFIGURING SAME

(71) Applicant: GNAX Holdings, LLC, Atlanta, GA (US)

(72) Inventor: Christopher Wayne HINKLE, Marietta, GA (US)

(73) Assignee: GNAX Holdings, LLC, Atlanta, GA (US)

(21) Appl. No.: 14/148,343

(22) Filed: Jan. 6, 2014

Related U.S. Application Data
(60) Provisional application No. 61/748,864, filed on Jan. 4, 2013.
(60) Provisional application No. 61/821,971, filed on May 10, 2013.

(51) Int. Cl. H02J 3/00; H02J 9/00

(52) U.S. Cl. CPC H02J 3/00; H02J 9/00
USPC 307/23; 307/18

(57) ABSTRACT

A system and methods for providing substantially uninterrupted electric power to one or more critical loads that significantly allows superior utilization of equipment and physical space, as well as reduction in the environmental footprint of systems for providing substantially uninterrupted electric power to one or more critical loads. The system and methods comprise an arrangement of power modules configured for providing substantially uninterrupted electric power to one or more critical loads using a combination of loads. The combination of loads generally follows a detailed method that comprises grouping of loads and mathematically determining the power relationships between the power modules and one or more loads. Generally, the method comprises determining the characteristics of the power lines that deliver substantially uninterrupted electric power from the power modules to one or more critical loads. Further, the system may comprise a plurality of power delivery architectures.

### CROSS REFERENCE TO RELATED APPLICATIONS

This application claims benefit under 35 U.S.C. §119(e) of U.S. Provisional Patent Application No. 61/748,864, filed Jan. 4, 2013, and entitled “Multiple Input Uninterruptable Power Supply (MI-UPS) Systems” and U.S. Provisional Patent Application No. 61/821,971, filed May 10, 2013, and entitled “Neural Power Distribution Systems”, both of which are incorporated herein by reference as if set forth herein in their entireties.

### TECHNICAL FIELD

The present disclosure relates generally to power systems, as well as their configuration and deployment in a physical location. More particularly, the present disclosure relates to power systems for providing an uninterruptible supply of electrical power to one or more critical loads.

### BACKGROUND

A mission critical system is a system that is essential to the survival of a business or organization. Many organizations or enterprises, such as those in the fields of financial transaction processing, emergency response, medical control, database management and process control, transportation, and many others, utilize many mission critical systems, and the organizations themselves are often considered mission critical. When a mission critical system fails or is interrupted, the operations of a business or organization may be significantly impacted. Ideally, these systems must be designed to ensure that electrical power is always available. Therefore, mission critical systems must be protected from scenarios resulting in the potential loss of power, and are generally powered by critical power systems that may comprise several layers of redundancy to ensure that the availability of the mission critical system is a high as possible.

Mission critical systems may achieve high availability by utilizing critical power systems that employ more than one independent power distribution branch. Each power distribution branch in the critical power system may include an independent power generation system, a utility power line, an automatic transfer switch (ATS), distribution components, breakers, power distribution units (PDUs) with step-down transformers, and any other power or distribution equipment as required by a particular power delivery architecture. Additionally, these power distribution systems are generally designed with an array of uninterrupted power supply (UPS) units on each power distribution branch, often configured with some degree of redundancy as well.

In an effort to provide a common reference, several organizations have developed standardized frameworks to define reliability levels across several industries. For example, the Uptime Institute defines four reliability levels for data centers in a quantifiable manner (see www.uptimeinstitute.com/TierCertification). The reliability levels are referred to as Tier levels, where Tier I facilities have the lowest expected availability, and generally comprise a single and non-redundant distribution system to serve the equipment in a facility. Tier IV facilities are considered the most robust and less prone to failures, and are generally designed to host mission critical systems requiring high availability rates.

Traditionally, mission critical systems in Tier IV facilities are generally powered by a critical power system with a primary and a redundant power distribution branch, and each power distribution branch is generally fed by a separate power source, such as a separate utility power line with mutually exclusive substations and transformers. During normal operation, each power distribution branch (primary and redundant) generally delivers about half of the power required by the mission critical system. In the event that a power distribution branch becomes unavailable, the other power distribution branch supplies the totality of the power required by the mission critical system. Therefore, during normal operation, a power distribution branch is generally utilized to a maximum of 50 percent of its total capacity, with about a 5 to 10 percent discretionary utilization percentage between the maximum capacity and the actual utilization of the power distribution branch. In other words, during normal operation, each power distribution branch is generally utilized to a maximum of about 40 to 45 percent of its total capacity. Therefore, in the event of a power distribution branch failure, the other power distribution branch is generally utilized to a maximum of about 80 to 90 percent of its total capacity.

In the case of an external power outage, such as a failure in a power substation that feeds a power distribution branch through a utility power line, an independent power generation system is promptly activated to maintain the power distribution branch as fully operational. In this type of scenario, an ATS disconnects the power distribution branch from the utility power line and connects the power distribution branch to the independent power generation system. Generally, each power distribution line has an independent power generation system, such as a diesel generator, attached thereto.

Such conventional methods and systems, however, have significant drawbacks. During normal operation, for example, a power distribution branch and corresponding components are generally utilized to less than half of their total capacity. Therefore, considering the high expected availability rate of critical power systems, the equipment components in each power distribution branch remain largely underutilized. In terms of equipment requirements, excess equipment capacity represents increased costs in producing a service or product relative to the revenues generated. Furthermore, underutilized equipment also represents underutilized physical space in a facility, which also increases costs and reduces efficiency. Additionally, due to laws and policies established by environmental protection agencies, facilities are generally constrained in growth by the limitations established relative to the size of power generators.

Therefore, there is a long-felt but unresolved need for a system or method that enables power systems, such as critical power systems, to relieve equipment underutilization and space misuse in the physical locations where the power systems are hosted. Further, there is a need for a system or method that allows facilities to provide environmental gains by reducing the footprint of power generators comprised by power systems thereby decreasing carbon emissions and increasing the efficiency of the power systems.

### BRIEF SUMMARY OF THE DISCLOSURE

Briefly described, and according to one embodiment, aspects of the present disclosure generally relate to combinatorial power systems that provide uninterruptable power to critical facility components in a highly-efficient and cost-effective manner.

According to one embodiment, a power system as described herein for providing substantially uninterrupted electric power to one or more critical loads allows superior utilization of equipment and physical space as compared to traditional power systems, as well as a reduction of the environmental footprint as compared to traditional power systems. Instead of traditional power delivery architectures for providing substantially uninterrupted electric power to one or more critical loads, for example, the power system comprises an arrangement of power modules configured for providing substantially uninterrupted electric power to one or more critical loads using a combination of loads, which in turn maximizes the utilization of the components of the power system. The combination of loads generally follows a detailed method that comprises grouping one or more loads into groups, and mathematically determining the power relationships between power supply modules and one or more loads. Generally, the method comprises determining the characteristics of the power lines that deliver substantially uninterrupted electric power from the power modules to one or more critical loads. Additionally, the described power system generally provides substantially uninterrupted electric power to one or more critical loads while significantly reducing the carbon emissions of a facility, as compared to a facility powered by a traditional power system.

Further, according to one embodiment, the power system may be deployed sequentially and modularly in a facility, for example, which in turn allows flexibility in electric planning as well as opportunity for electric code and safety compliance. Further still, according to one embodiment, the power system allows for substantial flexibility of component types, configurations, and number of components, for example, which can be applied to a variety of embodiments comprising virtually any number of power modules wherein the power system may also comprise a plurality of power delivery architectures known to one of ordinary skill in the art.

In certain embodiments described herein, loads are either physically or virtually divided into power zones having certain power requirements and needs. Correspondingly, preconfigured power modules, which generally include some combination of utility power and backup power (as described in greater detail below), are configured and operatively connected to the power zones in a manner that enables significantly higher utilization of the power equipment as compared to traditional systems. As described above, because conventional power components are individually underutilized (especially in power systems requiring redundant power supplies to support mission critical loads), by combining the power modules and zones in unique ways more of the power can be used without wasted space or power capability.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is an illustration of a comparison between a traditional power system for providing substantially uninterrupted electric power to one or more critical loads and an exemplary embodiment of the present disclosure.

FIG. 2A is an illustration of an exemplary system architecture of one embodiment of the present disclosure.

FIG. 2B is an illustration of the relationships among various components in one exemplary system architecture of one embodiment of the present disclosure illustrating.

FIG. 2C is an illustration of the relationships among various components in one exemplary system architecture of one embodiment of the present disclosure illustrating.

FIG. 3 is an illustration of the physical deployment of components of one exemplary system architecture of one embodiment of the present disclosure.

FIG. 4 is an illustration of an exemplary power module of one embodiment of the present disclosure.

FIG. 5 is an illustration of one embodiment of the present disclosure comprising multiple power delivery architectures.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

### Overview

Aspects of the present disclosure generally relate to combinatorial power systems that provide uninterruptable power to critical facility components in a highly-efficient and cost-effective manner.

According to one embodiment, a power system as described herein for providing substantially uninterrupted electric power to one or more critical loads allows superior utilization of equipment and physical space as compared to traditional power systems, as well as a reduction of the environmental footprint as compared to traditional power systems. Instead of traditional power delivery architectures for providing substantially uninterrupted electric power to one or more critical loads, for example, the power system comprises an arrangement of power modules configured for providing substantially uninterrupted electric power to one or more critical loads using a combination of loads, which in turn maximizes the utilization of the components of the power system. The combination of loads generally follows a detailed method that comprises grouping one or more loads into groups, and mathematically determining the power relationships between power supply modules and one or more loads. Generally, the method comprises determining the characteristics of the power lines that deliver substantially uninterrupted electric power from the power modules to one or more critical loads. Additionally, the described power system generally provides substantially uninterrupted electric power to one or more critical loads while significantly reducing the carbon emissions of a facility, as compared to a facility powered by a traditional power system.

Further, according to one embodiment, the power system may be deployed sequentially and modularly in a facility, for example, which in turn allows flexibility in electric planning as well as opportunity for electric code and safety compliance. Further still, according to one embodiment, the power system allows for substantial flexibility of component types, configurations, and number of components, for example, which can be applied to a variety of embodiments comprising virtually any number of power modules wherein the power system may also comprise a plurality of power delivery architectures known to one of ordinary skill in the art.

In certain embodiments described herein, loads are either physically or virtually divided into power zones having certain power requirements and needs. Correspondingly, preconfigured power modules, which generally include some combination of utility power and backup power (as described in greater detail below), are configured and operatively connected to the power zones in a manner that enables significantly higher utilization of the power equipment as compared to traditional systems. As described above, because conventional power components are individually underutilized (especially in power systems requiring redundant power supplies to support mission critical loads), by combining the power modules and zones in unique ways more of the power can be used without wasted space or power capability.

The discussion above in connection with an overview of the present disclosure is merely intended to provide a high-level description of embodiments of the present apparatuses and methods for combinatorial power systems. Accordingly, it will be understood and appreciated that the descriptions in this disclosure are not intended to limit in any way the ultimate scope of the present disclosure. Various embodiments of the present disclosure will be described with more particularity and for illustrative purposes next in greater detail.

### Exemplary Embodiments

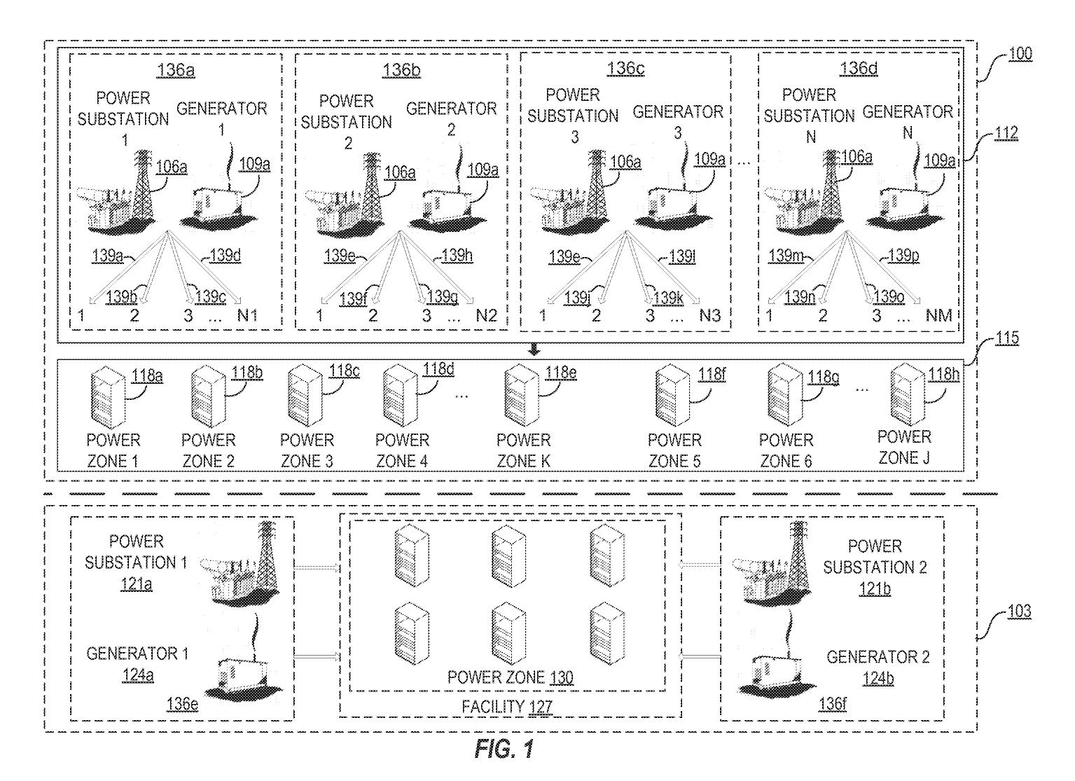

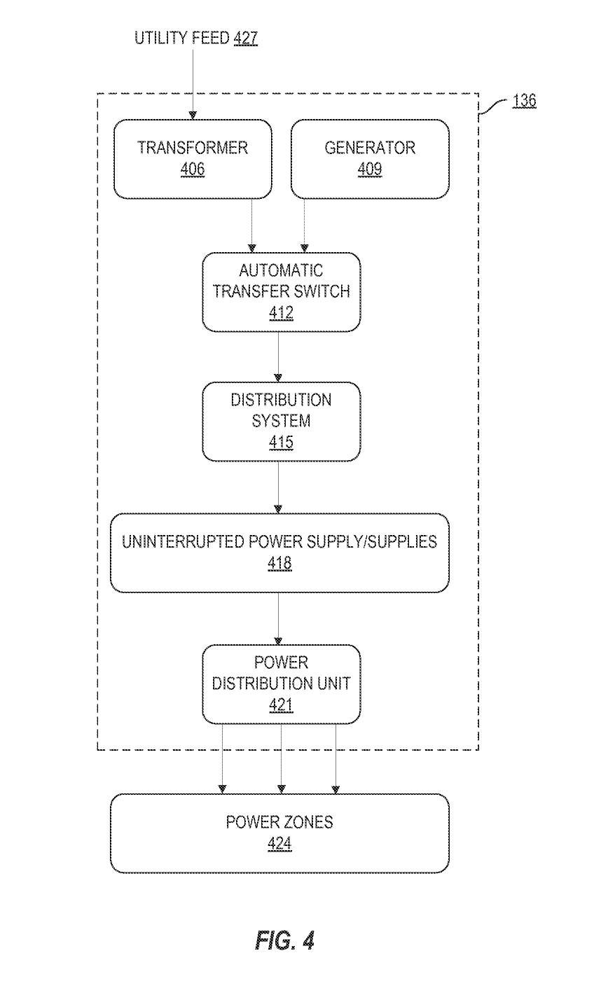

Referring now to the drawings, in which like numerals illustrate like elements throughout several drawing figures, FIG. 1 illustrates a comparison between traditional critical power systems 103, such as a critical power system in a Tier IV facility, and one embodiment 100 of the present disclosure. As mentioned previously, critical power systems are often used for mission critical systems that require an uninterruptable power supply. In data centers, for example, power delivery architectures with two or more independent branches of power distribution are generally used to add redundancy to the power delivery architecture. In FIG. 1, a traditional critical power system 103 utilizes two power distribution branches or power modules 136 to feed a system or facility 127, and each power module is comprised of two power sources, such as a power substation 121 and a generator 124. The details of power modules (or branches) 136 will be provided in greater detail below in connection with a discussion of FIG. 4.

Traditionally, each power module 136 may include an independent generation system (usually a diesel generator), a utility power line powered by mutually exclusive sub-stations and street transformers, distribution lines, breakers, and any other conditioning or distribution equipment as required by the power delivery architecture. The two power modules 136 feed the facility 127 simultaneously during normal operation, and each power module 136 supplies about half of the power required by the facility 103. In the event of a power failure or required maintenance, however, one of the power modules 136 may become unavailable. In such case, the power module 136 that remains active must supply the power for the entire facility 127. Therefore, as will occur to one of ordinary skill in the art, each power delivery branch or power module 136 is utilized to a maximum of about 40 to 45 percent of its total capacity during normal operation. In the event that one power module 136 becomes unavailable, however, the power module 136 that remains active is utilized to a maximum of about 80 to 90 percent of its total capacity. Additionally, the power modules 136 feed a set of loads (e.g. equipment comprised by a mission critical system) in the facility 103, where all the loads in the facility 127 comprise a single group or power zone 130.

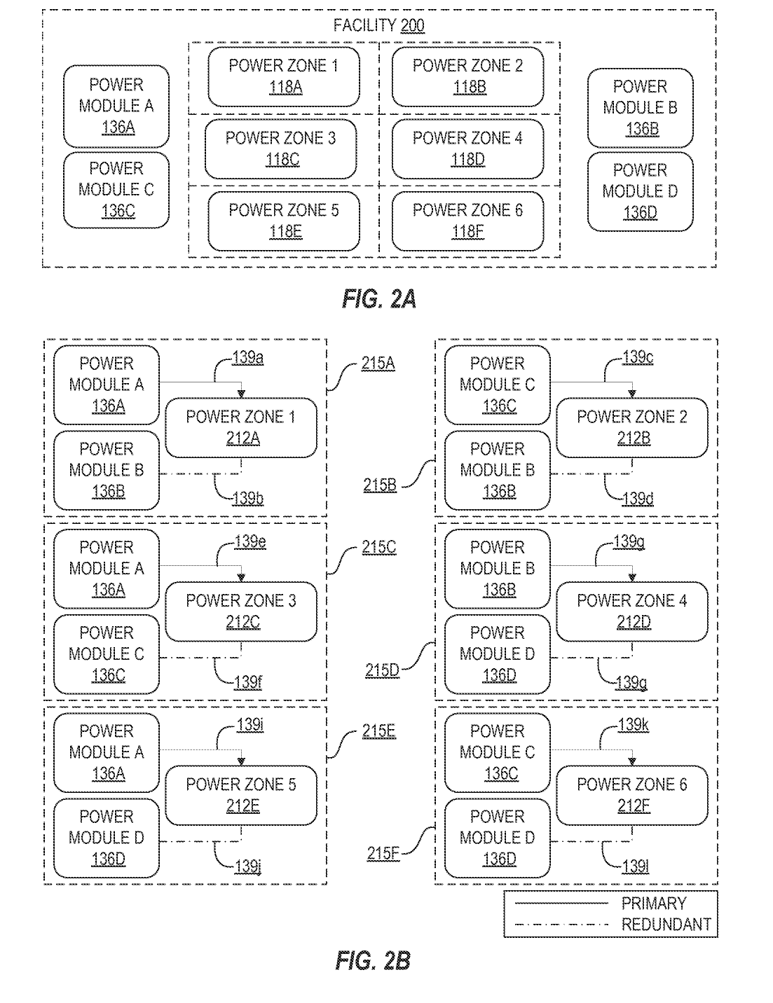

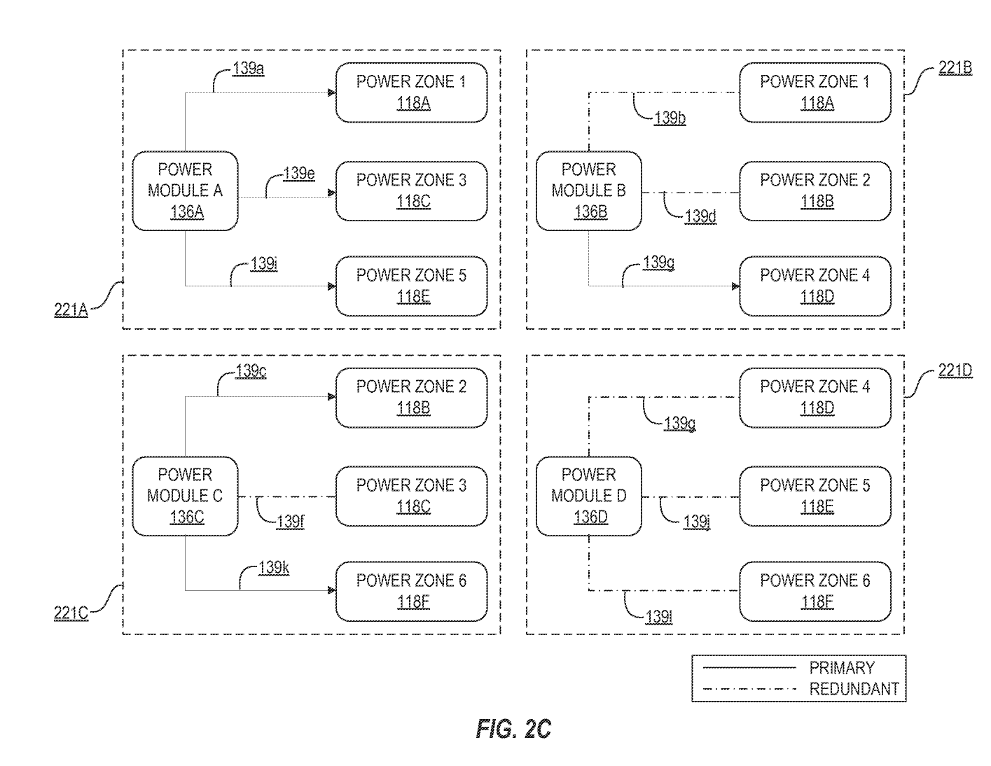

In contrast to a traditional system 103, embodiments of the present disclosure comprise combinatorial power systems 100 that include a plurality of power modules 136 and power zones 118 that are divided and combined to maximize the efficiency of the power system 100. In particular, and as shown in FIG. 1, a set of power modules 136 make up a power unit 112. In one aspect, a power module 136 is comprised of at least one power substation 106 and at least one generator 109, and the power modules 136 supply power to a facility 115, which comprises a set of loads divided into groups or power zones 118. Further details and examples of power modules, power zones, and the like will be shown and described later herein in connection with FIGS. 2-5.

As will be understood and appreciated, the components of the power unit 112 can be comprised of virtually any type of power source, and a plurality of power sources are possible according to various embodiments of the present disclosure. In one aspect, a load is any circuit connected to the power delivery architecture. For example, in a data center, the set of loads may include the computer and communication equipment, air conditioning, lighting, office space, etc. Generally, each power module 136 may comprise an independent generation system (usually a diesel generator), a utility power line powered by mutually exclusive sub-stations and street transformers, distribution lines, breakers, and any other conditioning or distribution equipment as required by the power delivery architecture. In one aspect, each power module 136 comprises power distribution units (PDUs) with step-down transformers and an array of uninterrupted power supply (UPS) systems configured in a redundant architecture. In certain embodiments, the UPS systems are arranged at the load level in a facility in a modular configuration with relatively small UPS systems, where the power is distributed across the various UPS systems. In another aspect, however, the UPS systems are configured in a centralized configuration with relatively large UPS systems, where a large portion of the power is assigned to a small number of UPS systems. In some embodiments, a large portion of the power is assigned to a single UPS system, where the rest of the power is assigned to the rest of the UPS systems in various amounts.

In one aspect, each power module 136 comprises at least one power line 139, and can comprise up to an unlimited number of power lines 139 as required by the configuration of the power system. For example, a power module 136a may comprise one power line 139a up to N1 power lines 139d, where N1 can be virtually any number. Likewise, a power module 136b may comprise one power line 139e up to N2 power lines 139h, where N2 can be virtually any number, and the same is true for any power module 136. As referred to herein, a “power line” 139 generally refers to the interconnect between a given power module and a corresponding power zone. Thus, the power line is used to deliver the necessary power from the power module to the power zone.

In one aspect, the power unit 112 comprises at least one power module 136, and can comprise up to an unlimited number of power modules 136 as required by the configuration of the power system 100. For example, the power unit 112 may comprise one power module 136a up to N power modules 136, where N can be virtually any number. In FIG. 1, an unlimited number of power modules 136d can also comprise one power line 139n up to NM power lines 139q, where NM can be virtually any number. In one aspect, however, a boundary will exist in the physical size of the facility 115 independent from the aspects discussed in the present disclosure, and therefore, the number of power lines 139 will also be limited. For example, the budget to build the facility, the availability of equipment and land, among others, are limiting factors to the size of the facility. Therefore, in one aspect, each power distribution branch or power module 136 has a limited number of power lines 139, and the power unit 112 has a limited number of power branches 136. As it will be understood and appreciated, the parameters relating to the interconnections among the facility 115, the power lines 139, and the power branches 136 are critical to maximizing the utilization rate of the equipment and providing reliability as required by mission critical systems.

As illustrated in the embodiment of FIG. 1, in order to feed the power zones 118 from the power unit 112, the power capacity of each power module 136 is divided into countable discrete quantities fed through power lines 139, and the power lines 139 feed the power zones 118 in the facility 115. In one aspect, the power zones 118 are assumed to possess equal power requirements, and the power capacity of each power line 139 is configured so that each power module supplies the same number of power zones 118. In another aspect, the power zones 118 possess varying power requirements. Therefore, the power capacity of each power line 139 is configured to compensate for the varying power requirements each power zone 118, and each power module may supply a different number of power zones 118.

In one aspect, a facility 115 comprises at least one power zone 118, and can comprise up to an unlimited number of power zones 118 as required by the configuration of the power system 100. In one aspect, a facility 115 may comprise one power zone referred to as power zone 1 118a and up to K power zones 118e, where K can be virtually any number of power zones 118 with the same power requirements. In another aspect, a facility 115 may comprise one power zone referred to as power zone 1 118a and up to K and J power zones 118e, where K and J can be virtually any number of power zones 118. In one aspect illustrated in FIG. 1, power zones 118 from 1 to K have different power requirements than power zones 118 from 5 to J. In another embodiment, however, power zones 118 from 1 to K have the same power requirements as power zones 118 from 5 to J. In one aspect, the power requirements of the power zones 118 change based on the size and type of the equipment requiring power, as well as the required reliability, and all the power zones 118 can different power requirements.

In one embodiment illustrated in FIG. 2A, a hypothetical system or facility 200 is comprised of a plurality of power zones 118 powered by a plurality of power modules 136. In one embodiment, the facility 200 is powered by power modules 136 of the same power capacity, and the individual power modules 136 are electrically isolated and physically compartmentalized. Further, necessary distribution procedures, such as distribution panels and breakers are implemented in the facility 200 to ensure safety and other code compliance measures as will occur to one of ordinary skill in the art.

As shown in FIG. 2A and FIG. 2B, four power modules 136 supply power to a facility 200. In one aspect, each power zone 118 possesses the same power requirements and each power zone 118 is fed by two power lines 139 that form a power line pair 215. For balancing the total power of the facility 200 evenly among the power lines 139 and power modules 136, the number of power lines pairs 215 that can be chosen from a set of power modules 136 is determined, where each power line 139 in each power line pair 215 is fed by a different power module 136 to avoid a single point of failure and add redundancy to the power system. This aspect can be generalized for any number of power modules 136 and power lines 139 by determining the number of power line 139 groups that can be formed from a set of power modules 136 of any size, where each power line 139 in each power line 139 group is fed by a different power module 136. In one aspect, the number of power line 139 groups that can be formed with equal power capacity from a set of power modules 136 of any size, where each power line in each power line group is fed by a different power module 136 is defined by the binomial coefficient shown in Equation 1 (described in greater detail below).

Equation 1 is used to determine the number of power zones 118 in the power system of a facility 200, where n is the number of power modules 136 and k is the number of power lines required by each power zone 118. In other words, Equation 1 determines the number of possible combinations in pairing independent power modules 136 with the power zones 118 by taking into account the number of power lines 139 required by each power zone 118. As mentioned previously, a power zone generally corresponds to a given load or combination of loads that require a predetermined amount of power within a facility.

In one exemplary embodiment illustrated in FIG. 2A, a facility 200 with six power zones 118 is powered by four power modules 136, as determined by Equation 1.

Because each power zone 118 requires two power lines 139 in this particular embodiment, there are a total of twelve power lines 139 connecting the power zones 118 and the power modules 136. This aspect can be generalized for any n number of power modules 136 as described in Equation 2, where the total number of power lines 139 in a facility 200 is the product of the number of power zones 118 and k, the number of power lines required by each power zone 118. Additionally, in one embodiment, the number of power lines 139 per power module 136 is determined by the ratio of the total number of power lines 139 to the number of power modules 136 in a facility 200 as described by Equation 3.

$$\begin{matrix} Total number of power zones = \frac{n !}{k ( n - k ) !} & Equation 1 \\ Total number of power lines = k \frac{n !}{k ( n - k ) !} & Equation 2 \\ Number of power lines per power module = \frac{k}{n} \frac{n !}{k ( n - k ) !} & Equation 3\end{matrix}$$

In one embodiment illustrated in FIG. 2B, the power lines running from the power modules 136 to the power zones 118 form power pairs 215. In one aspect, the number of power pairs 215 is equal to the number of power zones 118, as described by Equation 1, and each power zone 118 is shared across two power lines 139 in a power pair 215. In the event that a power line 139 supplying a power zone 118 becomes unavailable, such as during a failure or maintenance, the other power line 139 in the power pair 215 instantly compensates completely for the power loss without the necessity of manual or automatic switching. Power pairs 215 allow power zones 118 to have a redundant system of two power lines 139 that are mutually exclusive because each power line 139 in each power pair 215 is fed by a different power module 136 to avoid a single point of failure and to add redundancy to the power system.

In one aspect, the power lines 139 in each power pair 215 have the same power capacity, and the pairing is determined by Equation 1. Generally, in redundant power systems, such as Tier IV power systems, one power line 139 is referred to as a primary power line 139, whereas the other power line 139 is referred to as a redundant power line 139. However, although such categorical distinctions may be necessary in terms of classifying power lines for code compliance, there is generally no physical distinction between a primary and a redundant power line 139, as both are identical in operation. The notion of primary and a redundant power line 139 serves the purpose of identifying that two power lines 139 are used to enable a redundant supply to a load or a group of loads. Thus, any power line 139 associated with any power module 136 in the present disclosure can be considered either (or both) primary or redundant. Additionally, the power zones 118 illustrated in FIG. 2B are not necessarily physically separate zones 118.

FIG. 2C illustrates a breakout of the facility 200 referenced in FIGS. 2A and 2B, but with connections shown on a power module basis as opposed to a power zone basis. In one aspect shown in FIG. 2C, each power module 136 supplies three different power zones 118, and the power modules 136 and power zones 118 together comprise power groups 221. The term primary and redundant is once more applied to describe the purpose of utilizing two power lines 139. However, both power lines 139 are primary and redundant simultaneously, as each power line 139 generally supplies the same amount of power to a power zone 118 during normal operation. In the event that a power line 139 becomes unavailable, however, the power line 139 that remains available supplies the power of the entire power zone 118 to compensate for the power loss caused by the other power line 139. For example, power module A 136a supplies power to power zone 1 118a, power zone 3 118b and power zone 5 118c, which form a power group 221a. This power group 221a is mathematically unique because it is formed by the possible combinations in pairing two different independent power modules 136 with a power zone 118. In other words, each power module 136 supplies a unique set of three power zones 118. Therefore, in the event that a power module 136 becomes unavailable, the other three power modules 136 would each compensate for the power loss in each of the three power zones 118 compromised. For example, if power module A 136a experiences a failure, power module B 136b compensates for the power loss in power zone 1 118a, power module C 136c compensates for the power loss in power zone 3 118c, and power module D 136b compensate for the power loss in power zone 5 118e.

In one aspect, the concept of power groups 221 can be generalized for any n number of power modules 136 and power lines 139 as described in Equation 2, where the total number of power lines 139 in a facility 200 is generally the product of the number of power zones 118 and k, the number of power lines required by each power zone 118. The number of power groups 221 is generally equal to the number of power modules 136, and the number of power lines 139 in a power group 221 is generally determined by the ratio of the total number of power lines 139 in a facility 200 to the number of power modules 136 as described by Equation 3.

As described previously, most conventional systems significantly underuse their existing power infrastructure because power systems are not combined in ways to make efficient use of the redundancies. In one aspect, the target utilization rate of a system is described as UF_{target} where the target utilization rate UF_{target} is generally the maximum percentage utilized of the total capacity of the system under any circumstance or event. Generally, the target utilization rate UF_{target} can be reached when one or more power lines 139 become inactive, such as during maintenance or in the event of a system failure. In another aspect, the target utilization rate UF_{target} is the maximum power a system should deliver as compared to the maximum power the system can actually deliver. Generally, the target utilization rate UF_{target} is desirable when the safety or performance of the facility 200 are critical, and arises to ensure sufficient capacity beyond the expected loads in the facility 200. In one aspect, the target utilization rate UF_{target} is the margin of safety of the system, where the system is never utilized to its maximum capacity, and the maximum utilization of the system generally satisfies the power requirements of the facility 200.

Still referring to FIG. 2A, FIG. 2B and FIG. 2C, the power capacity of a power module 136 is referred to as module_{capacity}. In one aspect, the power capacity module_{capacity} is described in terms of the maximum recommended current a power module 136 can deliver to the power zones 118 at a specific voltage. For example, a power module 136 rated to deliver 400,000 volt-amperes (400 kVA) at 480 volts (three phase) can deliver a current of 481.4 amperes per phase. Therefore, in one aspect, increasing the power capacity module_{capacity} increases the current and power delivered to a power zone 118 for a constant voltage level. In another aspect, the number of power lines 139 per power module 136 is referred to as powerLines_{number}, where the total number powerLines_{number} is determined by the number of power lines 139 in a power group 221, or the ratio of the total number of power lines 139 in a facility 200 to the number of power modules 136 as described by Equation 3.

In one aspect, the target utilization rate of a specific power line 139 is referred to as UF_{AB}, where the target utilization rate UF_{AB} is generally the percentage utilized of the total capacity of a power line 139 during normal operation of a traditional critical power system, such as a Tier IV power system. Generally, the target utilization rate UF_{AB} is the power that a power line should deliver as compared to the maximum power the power line can actually deliver. In one aspect, the target utilization rate UF_{AB} is desirable when the safety or performance of the facility 200 is critical, and arises to ensure sufficient capacity beyond the expected loads in a facility. Generally, a traditional critical power system is never utilized to its maximum capacity, and the utilization of power lines 139 (and corresponding power modules 136) in a traditional critical power system at the target utilization rate UF_{AB} generally satisfies the power requirements of the facility.

In one aspect, the target utilization divergence rate of a power line 139 is referred to as UFdivergence_{AB}. Generally, the target utilization divergence rate UFdivergence_{AB} is the difference between the percentage utilized of the total capacity of a power line 139 and the target utilization rate UF_{AB} of the power line during normal operation. For example, if the target utilization rate UF_{AB} of a power line is 40 percent, but the power line can be utilized at 45 percent of its total capacity, the target utilization divergence rate UFdivergence_{AB} is five percent.

According to certain aspects, the target utilization divergence rate UFdivergence_{AB} comprises a discretionary alpha safety factor. In this regard, this alpha safety factor can be modified depending on the desires of a system implementer and the system requirements of a given system. Thus, as will be understood by one of ordinary skill in the art, the target utilization divergence rate can be determined (or, perhaps in some embodiments, ignored) and selected based on a variety of factors, and the specific examples and embodiments described herein are not intended to limit the spirit or scope of the disclosure in any way.

In one aspect, the number of concurrent failures a system may tolerate is described as failures_{number}. Generally, the number of concurrent failures failures_{number} is defined in terms of concurrent power module 136 failures in the system of the present disclosure or concurrent power module 136 failures in a traditional critical power system. Therefore, the number of concurrent failures failures_{number} generally refers to the number of simultaneous unavailable power modules 136 a system can tolerate before reaching the target utilization rate UF_{target}. In one aspect, as it will be appreciated and understood, the number of concurrent failures failures_{number} is dependent on the power delivery architecture and the number of power modules 136. Generally, the number of concurrent failures failures_{number} is described in the context of independent power modules 136 with mutually exclusive components, where the power system of a facility 200 comprises no single points of failure (e.g., any single component failure affects a single power module 136). In another aspect, however, a power system may comprises single points of failure (e.g., a single component failure may affect more than one power module 136), and the number of concurrent failures failures_{number} broadly applies to the number of concurrent failures a system may tolerate regardless of the interdependencies of the individual components of the power modules.

In one embodiment of the aspects presented in FIG. 2A, FIG. 2B and FIG. 2C, a method to determine the physical size and capacity of the power lines 139 is presented. In one hypothetical embodiment of the present disclosure, a facility 200 hosts a mission critical system that requires high power availability as described by the standards known to a person of ordinary skill in the art. The mission critical system is comprised of four power modules 136, and the four power modules 136 are generally independent of one another. The equipment comprised by the mission critical system in the facility 200 requires two mutually exclusive power lines 139 to add redundancy to the mission critical system. Therefore, Equation 1 is generally used to determine the total number of power zones 118 in the facility 200, where it is determined that six power zones 118 comprise six power pairs 215. The total number of power lines 139 in the facility 200 is 12 as determined by Equation 2, and powerLines_{number} or the total number of power lines 139 per power module 136 is three, as described by Equation 3.

As described by Equation 4 (shown below), the capacity of the power lines 139 is referred to as powerLine_{capacity}, where the capacity of the power lines 139 powerLine_{capacity} is generally dependent on the maximum target utilization rate UF_{target}, the power capacity module_{capacity} of each power module 136, the number of power lines per power module 136 powerLines_{number}, the target utilization rate UF_{AB}, the target utilization divergence rate UFdivergence_{AB} and number of concurrent failures failures_{number} the system in facility 200 can tolerate. In Equation 4, the power module 136 capacity module_{capacity} is generally multiplied by the maximum target utilization rate UF_{target} to determine the power that a power module 136 should target under failure conditions or when one or more power modules 136 become unavailable. Generally, the power that the power module 136 should target under failure conditions or when one or more power modules 136 become unavailable is divided by an adjusting factor, which accounts for the target utilization rate UF_{AB} and the target utilization divergence rate UFdivergence_{AB}. The power that a power module 136 should target under failure conditions or when one or more power modules 136 become unavailable is also divided by the power that is transferred from one power module 136 to the remaining power modules when a power module becomes unavailable, such that the available power modules operate at the maximum target utilization rate UF_{target}.

Generally, Equation 4 describes that some number of failures may occur before the system powering a facility 200 becomes utilized beyond the target utilization rate UF_{target} for a given number of power modules 136 of a given power capacity module_{capacity}. Generally, the power modules 136 are not utilized to the target utilization rate UF_{target,} which may result in increased efficacy as compared to traditional critical power systems, such as increased utilization of equipment and components, and higher amount of failures tolerated for a given power line 139 capacity powerLine_{capacity}. As mentioned above, a power line generally relates to the physical interconnect for delivering power from a power module to a given power zone. By utilizing Equation 4 in this exemplary embodiment, the capacity of the power lines 139 powerLine_{capacity} is 685 kVA for a system with 0.4 target utilization rate UF_{AB}.

$$powerLinecapacity = \frac{{UF}_{target} {module}_{capacity}}{a + b} \\ a = {powerLines}_{number} ( {UF}_{AB} + {UF}_{divergenceAB} ) \\ b = {UF}_{AB} {failures}_{number} \qquad Equation 4$$

An exemplary embodiment of a system enabled by the method defined in the present disclosure represents a higher utilization of components as compared to traditional critical power systems. In traditional critical power systems in a facility 127, the capacity of a power line would be defined as the ratio of the capacity of a power module 136 to the number of power lines per distribution branch 139. For example, in a traditional critical power system in a facility 127 with two power modules 136 with a capacity of 1500 kVA and two power lines, the capacity of each power line is 1500 kVA. Therefore, if UF_{target} is 0.8 and UFdivergence_{AB} is 0.05, each power line and each power module 136 is utilized at 37.65 percent of their total capacity during normal operation. In general, because traditional critical power systems employ no modularity and no combination of loads, each power module 136 is generally utilized at approximately half of the product of UF_{target} and UFdivergence_{AB} for any number of power modules 136 and power lines. For example, if UF_{target} is 0.8 and UFdivergence_{AB} is 0.05, each power module is utilized at 37.65 percent of the total capacity of each power module. In another example, if UF_{target} is 0.8 and UFdivergence_{AB} is 0.0, each power module 136 is utilized at 40 percent of the total capacity of each power module 136.

Now consider an exemplary embodiment of a system supplying power to a facility 200 where the power capacity module_{capacity} of each of four power modules 136 is 1500 kVA, the maximum target utilization rate UF_{target} is 0.8 (i.e., 80 percent), the target utilization divergence rate UFdivergence_{AB} is 0.05 (i.e., five percent), the target utilization rate UF_{AB} is 0.4, the number of concurrent failures failures_{number} is one, and each power zone 118 requires two independent power lines 139. For such a system, the capacity of the power lines 139 powerLine_{capacity} is 685.71 KVA as described by Equation 4. As described by Equation 3, for such a system in a facility 200, each power group 221 comprises three power lines 139. In other words, for such a system, each power module 136 supplies power to three power lines 139. In one aspect, each power line 139 is utilized at the target utilization rate UF_{AB} 0.4. Therefore, each power module 136 supplies 822 kVA to the facility 200 as described in Equation 5. An 822 kVA power supply in a module 136 represents 54.8 percent of the 1500 kVA power capacity module_{capacity} of each module. In one aspect, as compared to a power module 136 in a traditional critical power system in a facility 127 with two power modules 136 of 1500 kVA module_{capacity}, 0.40 target utilization rate UF_{AB} and 0.05 target utilization divergence rate UFdivergence_{AB}, each power module is utilized at 37.65 percent of its 1500 kVA power capacity module_{capacity}. In another aspect, as compared to a power module 136 in a traditional critical power system in facility 127 with two power modules 136 of 1500 kVA module_{capacity}, 0.40 target utilization rate UF_{AB} and 0.0 target utilization divergence rate UFdivergence_{AB}, each power module is utilized at 40 percent of the 1500 kVA power capacity module_{capacity} of each module.

utilization=powerLines_{number}(UF_{AB}powerLinecapacity) Equation 5

In another embodiment, a system supplying power to a facility 200 is enabled by the method described in the present disclosure, where the power capacity module_{capacity} of each of eight power modules 136 is 1500 kVA, the maximum target utilization rate UF_{target} is 0.8 (i.e. 80 percent), the target utilization divergence rate UFdivergence_{AB} is 0.0 (i.e., zero percent), the target utilization rate UF_{AB} is 0.4, the number of concurrent failures failures_{number} is three, and each power zone 118 requires two independent power lines 139. For such a system, and applying Equation 1, Equation 2 and Equation 3 the system has 28 power zones 118, 56 power lines 139, and 7 power lines 139 per power module 136 powerLines_{number}. For such a system supplying power to a facility 200, the capacity of the power lines 139 powerLine_{capacity} is 300 kVA as described by Equation 4. If each power line 139 is utilized at the target utilization rate UF_{AB} 0.4, each power module 136 supplies 840 kVA to the facility 200 as described by Equation 5. An 840 kVA power supply in a power module 136 represents 56 percent of the 1500 kVA power capacity module_{capacity} of each module. In one aspect, as compared to a power module 136 in a traditional critical power system in facility 127 with two power modules 136 of 1500 kVA module_{capacity} and 0.40 target utilization rate UF_{AB} and target utilization divergence rate UFdivergence_{AB} is 0.05, each power module 136 is utilized at 37.65 percent of the 1500 kVA power capacity module_{capacity} of each module. In another aspect, as compared to a power module 136 in a traditional critical power system in a facility 127 with two power modules 136 of 1500 kVA module_{capacity}, 0.40 target utilization rate UF_{AB} and 0.0 target utilization divergence rate UFdivergence_{AB}, each power module is utilized at 40 percent of the 1500 kVA power capacity module_{capacity} of each module.

An exemplary embodiment of a system enabled by the method defined in the present disclosure represents a reduction of equipment and components as compared to traditional critical power systems. In one embodiment, a system supplying power to a facility 200 is enabled by the method described in the present disclosure, where the power capacity module_{capacity} of each of four power modules 136 is 1500 kVA, the maximum target utilization rate UF_{target} is 0.8 (i.e., 80 percent), the target utilization divergence rate UFdivergence_{AB} is 0.05 (i.e., five percent), the target utilization rate UF_{AB} is 0.4, and each power zone 118 requires two independent power lines 139. For such a system in a facility 200, the capacity of the power lines 139 powerLine_{capacity} is 685.71 KVA as described by Equation 4. As described by Equation 3, for such a system in a facility 200, each power group 221 comprises three power lines 139. In other words, for such a system in facility 200, each power module 136 supplies power to three power lines 139. If each power line 139 is utilized at the target utilization rate UF_{AB} 0.4, each power module 136 supplies 822 kVA to the facility 200 as described in Equation 5. With four power modules 136 in the system in facility 200, the power served to the facility is 4500 kVA breaker power during normal operation, such as when every power module 136 is active. For a traditional critical power system in facility 127, with two power modules 136 and a 0.40 target utilization rate UF_{AB}, the power module 136 capacity module_{capacity} of each module must be 3000 kVA to supply 3000 kVA to a facility during normal operation, such as when every power module 136 is available. A 3000 kVA served power system capacity of a traditional critical power system in facility 127 represents a 33.5 percent difference as compared to a 4500 kVA served power system capacity in facility 200. Therefore, in one aspect, a system enabled by the method defined in the present disclosure and having the properties described immediately above achieves a 33.5% reduction of equipment and components as compared to traditional critical power systems. Further, the 33.5% reduction enables a power system to utilize the same amount of equipment and generate a higher capacity power system.

In another embodiment, a system supplying power to a facility 200 is enabled by the methods and apparatuses defined in the present disclosure, where the power capacity module_{capacity} of each of eight power modules 136 is 1500 kVA, the maximum target utilization rate UF_{target} is 0.8 (i.e., 80 percent), the target utilization divergence rate UFdivergence_{AB} is 0.0 (i.e., zero percent), the target utilization rate UF_{AB} is 0.4, the number of concurrent failures failures_{number} is three, and each power zone 118 requires two independent power lines 139. For such a hypothetical system in the facility 200, and applying Equation 1, Equation 2 and Equation 3, the system has 28 power zones 118, 56 power lines 139 and 7 power lines 139 per power module 136 powerLines_{number}. For such a system supplying power to a facility, the capacity of the power lines 139 powerLine_{capacity} is 300 kVA as described by Equation 4. If each power line 139 is utilized at the target utilization rate UF_{AB} 0.4 and each power module 136 supplies 840 kVA to the facility 200 as described in Equation 5, then the total capacity served by the system is 8400 kVA. For a traditional critical power system in facility 127, with two power 6000 kVA modules 136, and with a 0.40 target utilization rate UF_{AB}, the system will serve 6000 kVA, which is 28.5 percent reduction in power served utilizing the aforementioned exemplary model with 1500 kVA power module capacity module_{capacity} and 8 power modules. Therefore, in one aspect, a system enabled by the method defined in the present disclosure for a hypothetical power system as described immediately above achieves a 28.5% reduction of equipment and components as compared to traditional critical power systems 127.

As will be understood and appreciated, the hypothetical systems described above and herein are presented for illustrative purposes only, and are not intended to limit the scope of the present disclosure in any way. Additionally, the results from calculations utilized in the present disclosure represent approximations of the actual values and therefore may include rounding measures and/or calculation errors. These rounding measures and/or calculation errors should not limit the spirit of the present disclosure in any way. The equipment reductions presented in the exemplary embodiments provide environmental gains by reducing the footprint of power generators comprised by power systems thereby decreasing carbon emissions and increasing the efficiency of the power systems. Further, the method described in the present disclosure can be generalized for any number of power modules 136, power lines 139 and power zones 118, as will occur to one of ordinary skill in the art. In some circumstances, to accomplish the above hypothetical systems in practice, a multi-layer combinatorial power system may be implemented, such that a second power system is layered on top of a first power system. Such a system is akin to a “combinatorial power system in the cloud,” to borrow a term from network computing.

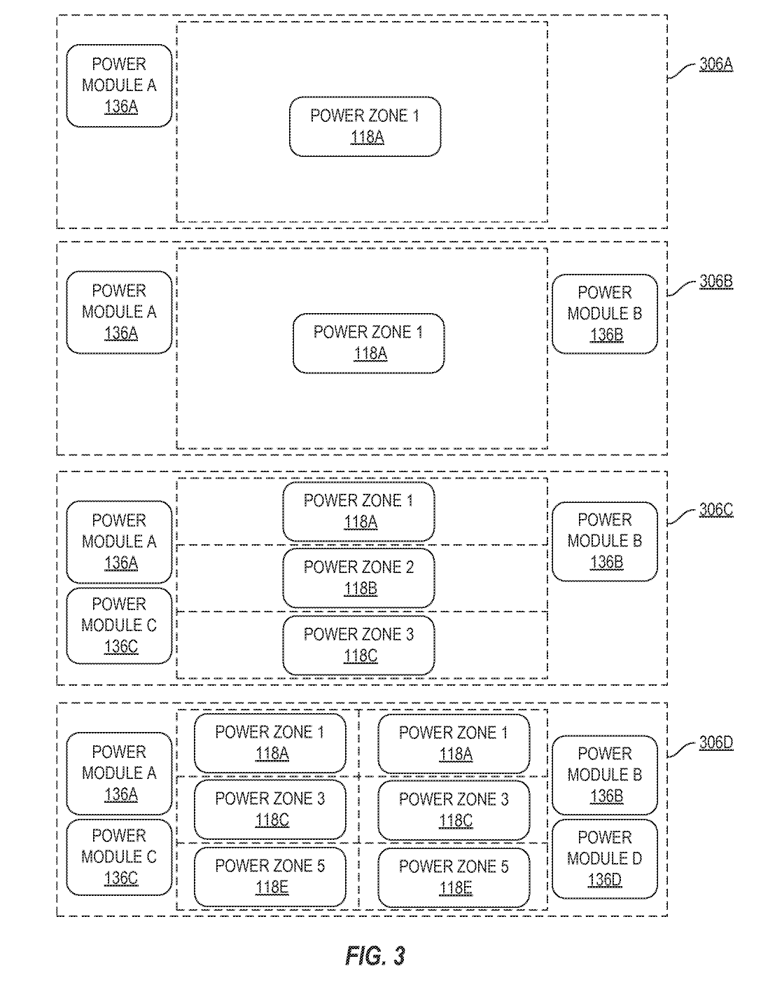

In one embodiment illustrated in FIG. 3, a method to deploy the power lines 139 in a facility 200 as the power modules 136 are implemented is illustrated. In one aspect, the power modules 136 in a facility 200 are implemented in a sequential order and Equation 1 is used to determine the number of power zones 118 in the facility 200, where n is the number of power modules 136 and k is the number of independent power lines 139 required by each power zone 118. In one aspect, when the number of power modules 136 n is one, there is only one power zone 118a in the facility 200 as illustrated by the first implementation stage 306a. In another aspect, when the number of power modules 136 n is two and the number of independent power lines 139 k required by each power zone 118 is two, there is one power zone 118a in the facility 200 as described by Equation 1 and illustrated by the second implementation stage 306b. In another aspect, when the number of power modules 136 n is three and the number of independent power lines 139 k required by each power zone 118 is two, there are three power zones 118 in the facility 200 as described by Equation 1 and illustrated by the third implementation stage 306c. In another aspect, when the number of power modules 136 n is four and the number of independent power lines 139 k required by each power zone 118 is two, there are six power zones 118 in the facility 200 as described by Equation 1 and illustrated by the fourth implementation stage 306d.

In one aspect, the implementation stages 306 enable different spatial configurations of power lines 139 deployed in a facility 200. The power lines 139 can be electrically and physically separated. Physical separation of the power lines 139 mitigates disturbances (e.g., arc flashes) that can originally occur in a power line 139 and consequently affect another power line 139 within a given physical separation. Generally, a disturbance such as an arc flash on a power line 139 that affects another power line 139 in a power pair 215 negates the benefits of deploying two independent power lines 139 to a power zone 118. Therefore, the power lines 139 may be deployed physically separated from each other during the different deployment stages 306. For example, a power line 139 can be deployed along the floor of a facility 200 while another power line is deployed along the ceiling of a facility 200, thus promoting physical separation between the lines.

FIG. 4 illustrates one exemplary embodiment of a power module 136 according to the present disclosure. As described above, a given power module generally includes all of the necessary components to deliver a predetermined amount of power to a load or loads. As further described above, in certain embodiments, each power module includes a utility power feed and a backup, independent power source (e.g., a generator). In the aspect shown in FIG. 4, each power module 136 may be comprised of at least one or a combination various utility power lines 427, transformers 406, power generators 409, ATSs 412, power distribution components or systems 415, PDUs 421, UPS units 418, and any other power or distribution equipment as required by a particular power delivery architecture. In one aspect, each power module 136 may be comprised of at least an independent power generation system 409, at least one utility power line 427, at least one ATS (or other type of switchgear) 412, at least one distribution system 415, at least one PDU 421, at least one UPS unit 421, and any other power or distribution equipment as required by a particular power delivery architecture. In another aspect, each power module 136 comprises a utility power line 427 from mutually exclusive transformers 406 or power substations. Generally, the utility power line 427 is delivered by the local utility company, and connects to at least one ATS 412 in a power module 136. The ATS 412 is generally fed by the utility power line 427 and an emergency power line provided by an independent power generator 409, such as a diesel generator. As will be understood and appreciated by those of ordinary skill in the art, an ATS as described herein is generally synonymous with a breaker or other type of switchgear as will be needed for specific power system requirements. While the utility power line 427 is available, the ATS relays the power to a series of distribution systems 415, such as distribution breakers and general electric distribution components. Generally, the power distribution system 415 comprises large breakers designed to carry large amounts of power to the UPS units 418 and other facility infrastructure such as lighting, heating, ventilation, air conditioning, fire life safety systems, etc. In one aspect, if the utility power line 427 becomes unavailable, at least one power generator 409 is activated to provide power to the facility 200. Generally, it requires several seconds for the power generator 409 or power generators 409 to reach a fully operational state. Once the ATS determines that the power generator 409 has reached a fully operational state and is able to supply power to the facility 200, the ATS disconnects the utility power line 427 and connects the power generator 409 to the distribution system 415.

As will be understood and appreciated by one of ordinary skill in the art, a power module 136 need not include all of the elements or components shown and described in FIG. 4. For example, a generator 409 is not necessary for many applications in which aspects of the current disclosure may be used. Further, an uninterrupted power supply 418 or a power distribution unit 421 similarly may not be needed in many applications. Additionally, in some embodiments, a separate an independent power substation 121 (feeding a utility power line 427) is not required for each independent power module 136. For example, a single power substation 121 may be used to provide utility power to all or most of the power modules used in a given facility. Certain compliance standards (such as Tier IV certification) can still be met even if a common substation s used to feed multiple power modules. Thus, as will be understood and appreciated, various embodiments and variations of the power module 136 are possible according to aspects of the present disclosure.

In the aspect shown in FIG. 4, once the power is delivered through the ATS 412 and the distribution system 415, the power is delivered to the UPS unit or units 418. Generally, the UPS unit or units 418 comprise an array of batteries designed to power the facility 200 during the time the power generator or generators 409 require to become fully operational after the utility power line 427 becomes unavailable. Additionally, the UPS unit or units 418 generally possess the ability to clean the incoming power from the utility power line 427 or a power generator 409. Voltages on a utility power line 427 may fluctuate significantly, which is generally detrimental to electronic equipment. Therefore, UPS unit or units 418 generally clear the voltage fluctuations on the power supply by converting the incoming alternating current (AC) to direct current (DC) and then back to alternating current (AC).

In one aspect, the power is delivered from the UPS unit or units 418 to a group of PDUs 421. The voltage is generally excessively large for most electronic equipment at this point. Therefore, the PDUs 421 or a separate transformer convert the power supply to a lower voltage that is usable by the electronic equipment, such as 120 VAC or 277 VAC. Subsequently, once the voltage is converted, the power is generally distributed to electrical outlets via power distribution gear, such as electrical breakers. PDUs 421 may be also capable of performing electric measurements, load balancing, alarm and fault monitoring, and automatic switching between to two power sources during a power outage. In one aspect, the electronic equipment in the facility 200 is connected to the outlets powered by the PDUs 421. In data centers for example, the outlets may comprised of several sets of power strips mounted on the server racks to provide power to the servers. Generally, the power that reaches the servers is clear of detrimental voltage fluctuations, and is protected by a redundant critical power system. In one aspect, each group of PDUs 421 in a power module 136 delivers power to power zones 118 according to the relationships described by Equations 1-5.

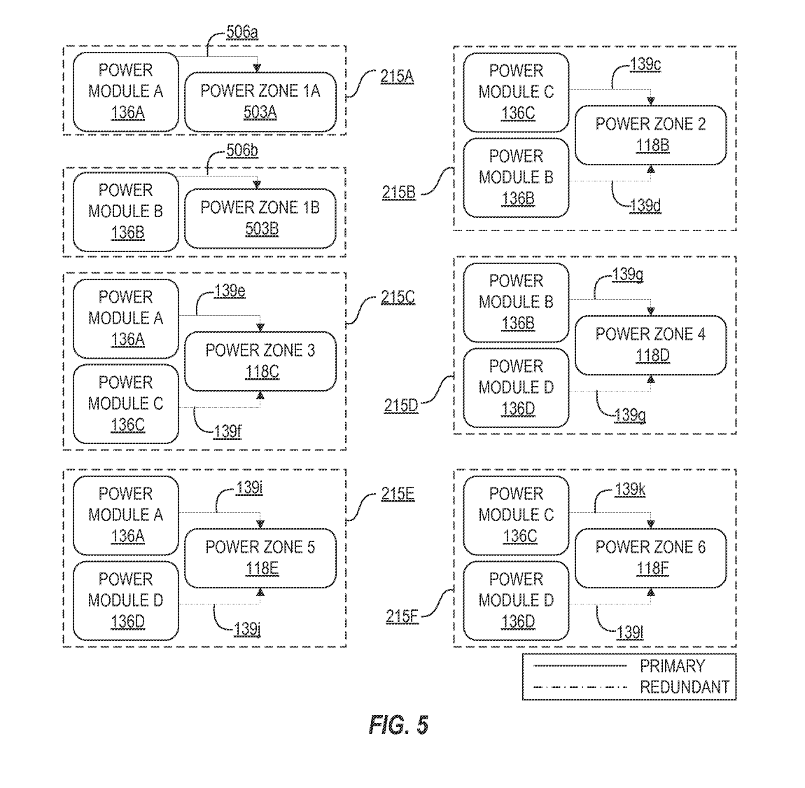

In one embodiment described in FIG. 5, power pairs 215 (described previously above in connection with FIG. 2) are configured so that some power zones 118 are fed by two independent power modules 136 and some power zones 118 are fed by a single power module 136 in a facility 200. In particular, some power applications require less redundancy, less sophistication, or different power capabilities than other power zones (loads) in a given facility. Thus, a need arises for a modular and variable power infrastructure. For example (and as shown in FIG. 5), power zone 2 118B, power zone 3 118C, power zone 4 118D, power zone 5 118E, and power zone 6, 118F, are fed by two independent power modules 136, while power zone 1 118A is divided into two power zones (power zone 1A 503A and power zone 1B 503B), where each power zone 503 is fed by a single power module 136. In one aspect, the power lines that feed power zone 1A 503A and power zone 1B 503B generally comprise power lines of smaller capacity as compared to the power lines that feed the remaining of the power zones 118B-118E. Preferably, the capacity of the power lines 506 that feed power zone 1A 503A and power zone 1B 503B are determined according to the guidelines of traditional critical power systems.

For example, a power module 136 in a non-redundant traditional critical power system (i.e., in which power zones are fed by a single power module) with a capacity of 1500 kVA can feed three power lines, each with a capacity of 500 kVA, where each power line is generally utilized at 80% of the total capacity of each power line. In one exemplary hypothetical embodiment, a blend of non-redundant and redundant architectures may be utilized, whereby a hypothetical zone 1 (e.g., zone 212A from FIG. 2B) can be split into two non-redundant zones, as shown in FIG. 5. In this scenario, the same power line sizing per Equation 4 (described above) is utilized for all of the existing redundantly fed power zones, while the feed from 136A to 503A and from 136B to 503B is simply divided by two. For example, with 4 power modules 136 at a module capacity of 1500 each, and a 0% divergence factor, 6 power zones exist with 3 power lines from each power module sized at 750 kVA. In this example, one redundant power zone is now subdivided into two non-redundant power zones 215A, and the feed sizes for both feeds are simply cut in half, and used to 80% capacity. This means that, under a failure condition, the loading of a power module may be 3*.4*750+.8*375=1200 kVA, which is equal to the target utilization factor of 80% under a single failure condition.

The methods presented in this disclosure have further flexibility, and the exemplary embodiments presented can be extended for a combination of several non-redundant and redundant power zones 503, 118 for any number of power modules 136 and power lines 506, 139 as described by Equations 1-5.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

What is claimed is:

1. A power distribution system, comprising:
a plurality of power modules configured for supplying power in a facility, wherein each power module comprises a predetermined number of power lines for supplying power to power zones in the facility; and
a plurality of power zones in the facility operatively connected to the plurality of power modules in a predetermined configuration to receive power from the plurality of power modules, wherein each power zone is operatively connected to one or more power modules via one or more power lines,
whereby the predetermined configuration of power zones and power modules is determined as a function of the number of power zones in the facility, the number of power lines required by each power zone, and the number of power modules available to the facility, and wherein the power lines for at least one power module are shared between at least two different power zones.

2. The power distribution system of claim 1, wherein the number of power zones in the facility is determined according to the following equation:
$$PZ = \frac{n !}{k ( n - k ) !}$$
wherein PZ represents the number of power zones, n represents the number of power modules available to the facility, and k represents the number of power lines required by each power zone.

3. The power distribution system of claim 2, wherein the total number of power lines required for the facility is determined by multiplying the number of power zones in the facility by the number of power lines required by each power zone.

4. The power distribution system of claim 1, wherein the predetermined number of power lines included in each power module is determined according to the following equation:
$$PLM = \frac{k}{n} \frac{n !}{k ( n - k ) !}$$
wherein PLM represents the predetermined number of power lines included in each power module, n represents the number of power modules available to the facility, and k represents the number of power lines required by each power zone.

5. The power distribution system of claim 1, wherein each power module comprises at least one utility power feed and at least one independent power generator.

6. The power distribution system of claim 5, wherein each power module further comprises one or more of the following: at least one automatic transfer switch (ATS) or switchgear, at least one distribution system, at least one power distribution unit.

7. The power distribution system of claim 5, wherein each power module further comprises at least one uninterrupted power supply (UPS) system.

8. The power distribution system of claim 1, wherein each power module comprises three power lines that operatively connect and supply power to three different power zones.

9. The power distribution system of claim 1, wherein each power zone comprises one or more electrical loads.

10. The power distribution system of claim 1, wherein a first power zone is powered by at least one primary power line and at least one redundant power line, wherein the at least one primary power line is associated with a first power module and the at least one redundant power line is associated with a second power module.

11. The power distribution system of claim 10, wherein the first power module also includes a redundant power line that supplies power to a second power zone.

12. A method for configuring a power distribution system, comprising the steps of:
determining the number of power modules available for supplying power to a facility, wherein each power module comprises one or more power lines for supplying power to loads in the facility;
determining the number of power zones in the facility requiring power from the power modules, wherein each power zone includes one or more loads;
determining the number of power lines required by each power zone;
based on the number of power zones in the facility and the number of power lines required by each power zone, determining the number of power lines required for each power module; and
configuring the power distribution system based on the determined number of power modules available for supplying power to the facility, the determined number of power zones in the facility, and the determined number of power lines required for each power module, such that each power zone is operatively connected to the determined number of power lines required to supply power to the power zone, and that each of the power lines operatively connected to a respective power zone is respectively associated with a discrete power module.

13. The method of claim 12, wherein the number of power modules available for supplying power to the facility is predetermined.

14. The method of claim 12, wherein the number of power zones in the facility is determined according to the following equation:
$$PZ = \frac{n !}{k ( n - k ) !}$$
wherein PZ represents the number of power zones, n represents the number of power modules available to the facility, and k represents the number of power lines required by each power zone.

15. The method of claim 12, wherein the number of power lines required for each power module is determined according to the following equation:
$$PLM = \frac{k}{n} \frac{n !}{k ( n - k ) !}$$
wherein PLM represents the predetermined number of power lines required for each power module, n represents the number of power modules available to the facility, and k represents the number of power lines required by each power zone.

16. The method of claim 12, wherein the number of power lines required by each power zone is determined as a function of the power requirements of each power zone.

17. The method of claim 12, wherein each power module comprises at least one utility power feed and at least one independent power generator.

18. The method of claim 17, wherein each power module further comprises one or more of the following: at least one automatic transfer switch (ATS) or switchgear, at least one distribution system, at least one power distribution unit.

19. The method of claim 17, wherein each power module further comprises at least one uninterrupted power supply (UPS) system.

20. The method of claim 12, wherein each power module comprises three power lines that operatively connect and supply power to three different power zones.

21. The method of claim 12, wherein a first power zone is powered by at least one primary power line and at least one redundant power line, wherein the at least one primary power line is associated with a first power module and the at least one redundant power line is associated with a second power module.

22. The method of claim 21, wherein the first power module also includes a redundant power line that supplies power to a second power zone.
